(19) United States
(12) Patent Application Publication
(10) Pub. No.: US 2004/0104302 A1
(43) Pub. Date: Jun. 3, 2004

(54) Method and system for reducing engine induced vibration amplitudes in an aircraft fuselage

(76) Inventor: Detlef Schierenbeck, Bremen (DE)

Correspondence Address: FASSE PATENT ATTORNEYS, P.A., P.O. BOX 726, HAMPDEN, ME, 04444-0726, US

(21) Appl. No.: 10/639,199

(22) Filed: Aug. 11, 2003

(30) Foreign Application Priority Data
Aug. 10, 2002 (DE) 102 36 815.5

(51) Int. Cl. B64C 27/22; B64C 39/00

(52) U.S. Cl. 244/10

(57) ABSTRACT

Vertical and/or lateral acceleration sensors are mounted in or on the engines or pylons of an aircraft to measure the vibrations induced by the operating dynamics of the engines. The sensors provide measured vibration signals to a controller that generates control signals in response to and dependent on the measured vibration signals. The control signals are provided to the aileron actuators, so as to actuate the ailerons appropriately to counteract and thereby reduce the engine-induced vibrations. Thus, the engine-induced vibrations acting on the fuselage are diminished and the passenger flight comfort is significantly improved.

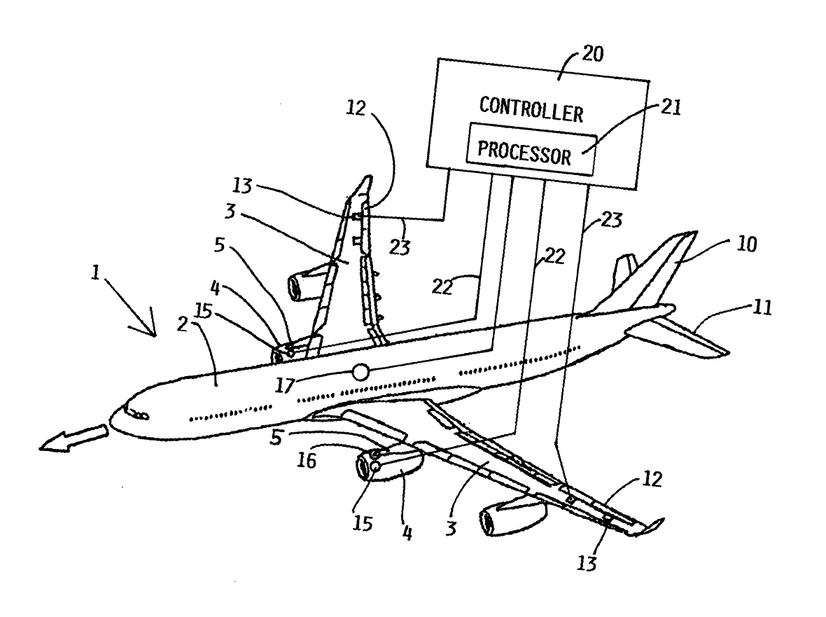

### PRIORITY CLAIM

This application is based on and claims the priority under 35 U.S.C. §119 of German Patent Application 102 36 815.5, filed on Aug. 10, 2003, the entire disclosure of which is incorporated herein by reference.

### FIELD OF THE INVENTION

The invention relates to a method and an arrangement or system for reducing the amplitudes of lateral and/or vertical vibrations and/or oscillations (generally called vibrations herein) induced in the fuselage of an aircraft by the operating dynamics of the engines of the aircraft.

### BACKGROUND INFORMATION

The operating engines of an aircraft must be considered as gyroscopic systems that exhibit various operating dynamics due to the rotating masses of the internal components and mechanisms of the engines. In turn, the fuselage of the aircraft exhibits a dynamic response characteristic to the operating dynamics of the engines, whereby vibrations and/or oscillations (generally called simply vibrations herein) are induced in the aircraft fuselage by the operating dynamics of the engines. Additionally, such vibrations can be induced in the aircraft fuselage due to the influence of wind gusts and the like. It has been found that such vibrations are especially significant in modern high capacity passenger transport aircraft equipped with rather long slender fuselages, and especially the stretched versions of various existing aircraft families or types, for example due to the greater flexibility and bending characteristics of such fuselages. In these high capacity stretched aircraft fuselages, the arising vibrations and/or oscillations can significantly influence (i.e. impair or detract from) the overall comfort of passengers in the aircraft during flight.

In order to improve the passenger comfort, so-called “Comfort in Turbulence” systems have been successfully utilized in the Airbus Series A330-200/300 and A340-200/300 aircraft. These systems aim to sense and then counteract vertical and/or lateral vibrations and/or oscillations in the aircraft fuselage, in order to thereby reduce the amplitude of such vibrations and thus improve the passenger comfort. In these conventionally known systems, acceleration sensors or accelerometers are installed solely in the aircraft fuselage so as to provide actual measured value signals representing the actually occurring vertical and/or lateral vibrations or oscillations of the fuselage. These actual measured value signals of the acceleration sensors are provided as inputs to control or regulation circuits which incorporate or embody a regulation rule set, and which, on the basis of the actual measured acceleration signals, generate control signals for controlling the elevators and/or the rudder of the aircraft for counteracting and thus reducing the actually existing vibration or oscillation amplitudes.

Thus, in the known systems, the control signals derived from the measured lateral accelerations are provided to the rudder of the aircraft in order to control the rudder to counteract and thus damp out the measured lateral vibrations or oscillations. Similarly, the control signals derived from the measured vertical accelerations of the fuselage are provided to the elevators of the aircraft to achieve a similar improvement or damping of the oscillation amplitudes of vertical accelerations of the fuselage. In these conventional systems, the vibrations and/or oscillations induced by the operation of the engines are only indirectly detected and influenced by the control of the elevators and rudder, with a corresponding reduced effectiveness, because the engine-induced vibrations are measured only indirectly, as a component of the overall vibrations of the fuselage, by the accelerometers arranged in the fuselage.

Moreover, in the design and particular set-up of the regulation rule set, the suitable filter coefficients to be used for evaluating the actual measured acceleration signals are strongly dependent on the existing fuel level and the overall loading of the aircraft. As a result, the sensitivity or precision of the regulation is further diminished as the fuel level and overall loading of the aircraft varies.

There are various other known methods and systems for sensing and then reacting to varying loads that act on the aircraft during flight and can cause vibrations or oscillations thereof, especially with regard to wind gust loads acting on the aircraft for example. In this regard, generally see U.S. Pat. No. 6,161,801 (Kelm et al.) and the references cited therein. The entire disclosure of U.S. Pat. No. 6,161,801 is incorporated herein for background information. The known conventional methods and systems in this context do not address and are not suitable for reducing vibration and oscillation amplitudes that are induced in the aircraft fuselage by the operation dynamics of the engines.

### SUMMARY OF THE INVENTION

In view of the above, it is an object of the invention to provide a method and an arrangement or system of the abovementioned general type, which can improve the damping or counteraction of engine induced vibrations and oscillations in the fuselage of an aircraft in a direct and active manner. The invention further aims to avoid or overcome the disadvantages of the prior art, and to achieve additional advantages, as apparent from the present specification.

The above objects have been achieved according to the invention in an arrangement for reducing, counteracting, and/or damping the amplitude of vibrations and/or oscillations induced in an aircraft fuselage by the operation of the engines. The inventive system includes a controller with a computer processor, and at least one sensor (preferably an acceleration sensor) arranged on or in the engine or at the forwardmost engine-pylon connection for sensing the lateral and/or vertical accelerations of the engine. The sensor or sensors are connected to the controller by sensor signal lines. The controller is further connected by control signal lines to actuators of the ailerons. Based on the acceleration signals received from the sensors, according to a prescribed rule set, the controller generates or issues control signals to the actuators of the ailerons, to adjust the positions of the ailerons so as to counteract and thereby reduce or damp out the particular vibrations and/or oscillations induced by the operation of the engines. The system may further include one or more acceleration sensors arranged in the aircraft fuselage itself.

The above objects have further been achieved according to the invention in a method for reducing lateral and/or vertical vibration amplitudes that are induced in the fuselage of an aircraft by the engine dynamics of the operating engines of the aircraft, for the purpose of improving the flight comfort of the passengers in the aircraft. The method involves detecting engine induced vibrations using at least one acceleration sensor for sensing the lateral and/or vertical accelerations on or in at least one engine or at a forwardmost connection between an engine and an engine mounting pylon. The inventive method further comprises providing the measured acceleration signals as an input for executing a prescribed regulation rule set and thereby generating a control signal dependent on the acceleration signals, and providing this control signal to an actuator of an aileron mounted on the wing of the aircraft. By appropriately controlling the position of the aileron, the measured vibrational accelerations are counteracted, reduced, and/or damped out in an active manner.

As mentioned above, operating aircraft engines must be regarded as rotating gyroscopic systems. Therefore, various internal and external excitations generate or lead to coupled oscillating motions with respect to yawing and pitching of the engines. This in turn induces similar motions, and particularly coupled elliptical motions in yaw and pitch, of the fuselage of the aircraft due to its particular dynamic response characteristic. For this reason, it is advantageously sufficient according to the invention, to measure only one acceleration magnitude in either the lateral direction or the vertical direction, and to use this measured acceleration magnitude or amplitude in only one direction as an input parameter for the prescribed regulation rule set. Namely, due to the coupling of the vibrating or oscillating motions in the lateral and vertical directions, it is generally only necessary to measure the acceleration in one of these directions. For particular situations, or to achieve an increased precision and an additional evaluation channel, the accelerations can be measured in both the lateral direction and the vertical direction.

In any event, use of the inventive method and system avoids the need for increasing the stiffness of the aircraft structure in an effort to reduce the engine induced vibrations or oscillations. Such stiffness alterations would be expensive, not very effective, and result in unacceptable increases of the weight of the aircraft.

Multi-engine aircraft typically use engines having the same rotation direction on both the right and left sides of the aircraft, i.e. mounted on the right and left wings of the aircraft. This results in an unsymmetrical aircraft vibration or oscillation behavior. Namely, a symmetrical behavior in this context would only be achieved by providing engines having opposite rotation directions respectively on the opposite sides of the aircraft. In any event, for this reason, the invention provides an embodiment in which an individual regulation is carried out for the corresponding engines on the left side and on the right side of the aircraft. A further embodiment of the invention aims to reduce the total number of required regulation rules, in that symmetrical or anti-symmetrical control signals for the ailerons on opposite sides of the aircraft can be determined by forming the sums or the differences of corresponding engine-induced vibration accelerations on opposite sides of the aircraft, rather than requiring an individual evaluation using an individual rule set for each side.

As a principle advantage, the invention achieves a considerably improved passenger comfort through a drastic improvement of the damping of the elastic oscillating movements of the aircraft fuselage. Additional advantages of the invention include: a direct regulating or counteracting influence on the engine vibration amplitudes with a considerably improved flight comfort; regulation rules that are independent of the fuel level and the overall loading of the aircraft; a significant improvement of flight comfort for the passengers, independent of lateral and vertical accelerations in the fuselage of the aircraft; and avoiding the need to substantially alter existing hardware or systems of the aircraft, which would lead to an increased weight of the aircraft, because the inventive method and system can easily be incorporated in and used together with the conventional systems already existing in an aircraft.

### BRIEF DESCRIPTION OF THE DRAWING

In order that the invention may be clearly understood, it will now be described in connection with an example embodiment, with reference to the single accompanying drawing FIGURE, which schematically represents an aircraft incorporating features of the present inventive system for carrying out the inventive method.

### DETAILED DESCRIPTION OF A PREFERRED EXAMPLE EMBODIMENT AND OF THE BEST MODE OF THE INVENTION

The single drawing FIGURE schematically shows an aircraft 1, including a fuselage 2, and two wings 3 protruding to the right and left sides of the fuselage 2. The aircraft 1 further includes various control surfaces such as a rudder 10, elevators 11, as well as ailerons 12 provided on the trailing edges of the wings 3. The ailerons 12 are actuated and controlled with respect to their deflection position by any conventionally known arrangement of actuators 13. The aircraft 1 further includes engines 4, such as any typical jet turbine engines, mounted by pylons 5 onto the wings 3. The just-described general components of the aircraft 1 may have any conventionally known design, construction, arrangement and operation. The special features of the inventive system in the aircraft 1 will be described next.

The inventive system includes a controller 20 incorporating a computer processor 21, which may be embodied in the existing flight control computer of the aircraft 1. The controller 20 executes one or more regulation rules making up a regulation rule set, by means of the computer processor 21.

The inventive system further includes acceleration sensors 15 mounted in or on one or more of the engines 4, for example on a nacelle or housing of the engine 4. Alternatively, or additionally, the inventive system includes one or more sensors 16 mounted in or on the pylon or especially at the forwardmost connection between the respective engine 4 and the pylon 5. Furthermore, the inventive system may comprise and make use of an additional acceleration sensor 17 mounted in or on the aircraft fuselage 2 itself. The various sensors 15, 16 and 17 are each adapted to sense vertical and/or lateral accelerations and to generate corresponding sensor signals indicative of the actual measured accelerations. The sensors 15, 16, and 17 are connected to the controller 20 by sensor signal conductor lines 22 (such as electrical or optical conductor cables), for providing the sensor signals as inputs to the regulation rule or rules in the controller 20.

Based on and dependent on the input sensor signals received from the sensors 15, 16 and 17, the execution of the regulation rule or rules in the controller 20 results in the generation of control signals for the ailerons 12. These control signals are transmitted from the controller 20 via control signal lines 23 (such as electrical or optical conductor cables) to the actuators 13 of the ailerons 12. Particularly, these control signals control the actuators 13 to appropriately deflect the ailerons 12 in a manner so as to counteract and thereby reduce or damp-out the lateral and/or vertical accelerations sensed by the sensors 15, 16 and 17. Particularly, the ailerons 12 are actuated so as to counteract the vibrations that are induced by the operating dynamics of the engines 4, as sensed by the sensors 15 and 16. As a result, the vibrations and/or oscillations that are induced in the fuselage 2 by the operating dynamics of the engines 4 are significantly reduced, because the ailerons induce a counteracting vibration or oscillation into the wings 3, so as to “cancel out” (to the extent possible) the engine-induced vibrations before such engine-induced vibrations can reach the fuselage 2 through the roots of the wings 3.

The regulation described above can be carried out individually and independently for the engines 4 on each side of the aircraft, by evaluating the sensor signals provided by the sensor or sensors mounted on the engine or engines on a given wing. i.e. a given side of the aircraft, and then actuating an associated one (or several) of the ailerons 12 on that wing to counteract the vibration of the engines on this wing, while carrying out a similar independent process with regard to the engines, sensors and ailerons of the other wing on the other side of the aircraft. Alternatively, the regulation can be carried out on a global or overall basis for all of the sensor signals.

According to a further embodiment of the invention, the total number of regulation rules in the controller 20 can be reduced by simply forming symmetrical and/or anti-symmetrical control signals to be provided to the ailerons 12 on opposite sides of the aircraft, based on forming the sums or differences of the actual measured vibrational accelerations of the engines on the two opposite wings. For example, the control signals for the left wing can be determined as discussed above based on the left wing sensor signals, while the control signals for the right wing can be determined as symmetrical or anti-symmetrical signals relative to the left wing control signals by forming the sums or differences of the left wing sensor signals relative to the right wing sensor signals.

Furthermore, the acceleration sensors can be provided redundantly for measuring the lateral and/or vertical accelerations, with more than one sensor on one engine, and/or with plural sensors on plural engines, and/or in addition to a fuselage acceleration sensor 17 as mentioned above.

The “lateral” direction referred to herein is a direction parallel to the pitch axis of the aircraft. The “vertical” direction referred to herein is a direction parallel to the yaw axis of the aircraft whether or not this direction is truly vertical relative to the earth.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. In an aircraft having a fuselage, right and left wings mounted to said fuselage, ailerons mounted on said right and left wings and actuated by respective actuators, and engines mounted by pylons respectively to said right and left wings,
an improvement comprising a system for reducing vibrations induced in said fuselage by operating dynamics of said engines, wherein said system comprises:
a controller including a computer processor;
at least one sensor mounted in or on at least one of said engines or at a forwardmost connection between one of said engines and an associated one of said pylons;
at least one sensor signal conductor line connecting said at least one sensor to said controller; and
at least one control signal conductor line connecting said controller to at least one of said actuators;
wherein said controller generates at least one control signal in response to and dependent on at least one sensor signal provided by said at least one sensor via said at least one sensor signal conductor line, and said at least one control signal is provided via said at least one control signal conductor line to said at least one actuator to control an actuation of said at least one actuator.

2. The system for reducing vibrations in the aircraft according to claim 1, wherein said at least one sensor comprises at least one acceleration sensor.

3. The system for reducing vibrations in the aircraft according to claim 2, wherein said at least one acceleration sensor includes an acceleration sensor with a sensitive axis oriented to sense vibrational accelerations in a vertical direction.

4. The system for reducing vibrations in the aircraft according to claim 3, wherein each said at least one acceleration sensor senses only vibrational accelerations in said vertical direction.

5. The system for reducing vibrations in the aircraft according to claim 2, wherein said at least one acceleration sensor includes an acceleration sensor with a sensitive axis oriented to sense vibrational accelerations in a lateral direction.

6. The system for reducing vibrations in the aircraft according to claim 5, wherein each said at least one acceleration sensor senses only vibrational accelerations in said lateral direction.

7. The system for reducing vibrations in the aircraft according to claim 5, wherein said at least one acceleration sensor further includes an acceleration sensor with a sensitive axis oriented to sense vibrational accelerations in a vertical direction.

8. The system for reducing vibrations in the aircraft according to claim 1, wherein said at least one sensor includes an acceleration sensor mounted in or on a respective one of said engines.

9. The system for reducing vibrations in the aircraft according to claim 1, wherein said at least one sensor includes an acceleration sensor mounted at said forwardmost connection between one of said engines and said associated one of said pylons.

10. The system for reducing vibrations in the aircraft according to claim 1, further comprising at least one additional acceleration sensor mounted in or on said fuselage and connected to said controller by at least one additional sensor signal conductor line.

11. A method of reducing an amplitude of vibrations induced in a fuselage of an aircraft by operating dynamics of engines of said aircraft, comprising the steps:
a) sensing a vibrational acceleration in or on at least one of said engines or on a forwardmost connection between one of said engines and a pylon mounting said one of said engines to a wing of said aircraft, and providing a first sensed acceleration signal corresponding to said vibrational acceleration;
b) executing at least one regulation rule to generate a first control signal responsive to and dependent on said first sensed acceleration signal; and
c) actuating at least one aileron on said wing of said aircraft responsive to and dependent on said first control signal so as to at least partially counteract said vibrational acceleration.

12. The method according to claim 11, wherein said vibrational acceleration is oriented in a vertical direction.

13. The method according to claim 11, wherein said vibrational acceleration is oriented in a lateral direction.

14. The method according to claim 11, wherein said vibrational acceleration includes an acceleration in a vertical direction and an acceleration in a lateral direction, which are both sensed.

15. The method according to claim 11, wherein said steps a), b) and c) are carried out respectively individually and independently for said wing on a right side of said aircraft and for another wing on a left side of said aircraft.

16. The method according to claim 11, wherein said steps a), b), and c) are carried out separately and individually for each one of said engines.

17. The method according to claim 11, further comprising sensing an additional acceleration in or on said fuselage and correspondingly providing an additional sensed signal, and taking said additional sensed signal into account as an additional input in said executing of said at least one regulation rule in said step b).

18. The method according to claim 11, further comprising sensing a second vibrational acceleration in or on a second one of said engines or on a forwardmost connection between said second engine and a second pylon to provide a second sensed acceleration signal corresponding to said second vibrational acceleration, and generating a second control signal that is symmetrical or anti-symmetrical relative to said first control signal by forming sums or differences of said first sensed acceleration signal and said second sensed acceleration signal.

19. The method according to claim 11, wherein said step a) comprises sensing said vibrational acceleration in or on said at least one of said engines.

20. The method according to claim 11, wherein said step a) comprises sensing said vibrational acceleration on said forwardmost connection between said one of said engines and said pylon.
